(19) United States
(12) Patent Application Publication
(10) Pub. No.: US 2017/0014923 A1
(43) Pub. Date: Jan. 19, 2017

(54) Dual Ended, Full Form Tooth Generating Gear Cutter and Associated Cutting Insert

(71) Applicant: Caterpillar Inc., Peoria, IL (US)

(72) Inventor: Richard G. Marsh, Lugoff, SC (US)

(73) Assignee: Caterpillar Inc., Peoria, IL (US)

(21) Appl. No.: 14/798,965

(22) Filed: Jul. 14, 2015

(51) Int. Cl. B23F 21/14; B23F 1/06

(52) U.S. Cl. CPC B23F 21/143; B23F 1/06

(57) ABSTRACT

A gear cutter is provided. At least one cutting insert is mounted on a body member. The cutting insert has a first end and a second end, the first end including side faces that are configured to converge inwardly toward each other as they extend to a tip portion, the side faces and the tip portion intersecting with a forward face so as to define a first cutting edge. The second end including side faces that are configured to converge inwardly toward each other as they extend to a tip portion. The side faces and tip portion intersect with the forward face so as to define a second cutting edge. Each of the cutting edges has a full involute configuration that matches a desired configuration of a gap between adjacent teeth of a gear.

### TECHNICAL FIELD

This disclosure relates generally to gear manufacturing and, more particularly, to a gear cutter and associated cutting insert for generating a tooth of a gear.

### BACKGROUND

In gear manufacturing, stock is removed from a round blank material to generate the teeth. This is typically done in multiple steps including a roughing step in which stock is initially removed from the gear blank and a finishing step in which the final tooth shape is generated. These different steps often utilize different fixtures and tooling that can require parts to be moved between different machines. This can be time consuming. Moreover, the movement of parts between the different machines may require separate part lifting devices that can increase the cost and complexity of the gear manufacturing process. The switching between different fixtures and tooling for the roughing and finishing steps can also make it more difficult to hold tolerances and maintain consistency in the separate cutting operations which can lead to lower quality, out-of-tolerance gears.

One way in which the stock can be removed from the blank material to generate a tooth is using a gear cutter. Gear cutters can include a disc shaped body on which a plurality of cutting inserts are mounted. The body of the gear cutter may be rotated so as to bring the cutting inserts sequentially into engagement with the blank material and thereby cutaway material to form the teeth of the gear. Gear cutters used for finish tooling have multiple overlaid cutting inserts that are typically only capable of generating a single gear tooth at a time. The overlaid cutting inserts used on such gear cutters can be expensive to produce and require significant time and expense to maintain.

U.S. Patent Pub. No. 2014/0010606 discloses a milling insert and milling tool that can be used in milling tooth slots of internal and external gear wheels. The disclosed milling tool includes multiple inserts removably mounted on seats formed in a body. Each insert is mounted such that its longitudinal axis extends radially with respect to the body of the milling tool. Moreover, each insert is configured with straight cutting edges. The disclosed milling tool is specifically designed for gear hobbing operations and is incapable of being used in profile milling or non-generative gear milling operations.

### SUMMARY

In one aspect, the disclosure describes a gear cutter for cutting a gap between adjacent teeth of a gear. The gear cutter includes a body member that is configured to be rotatable about a rotational axis. The body member has a perimeter. At least one cutting insert is mounted on the perimeter of the body member and including a forward face, a rear face and a center portion. The cutting insert having a first end and a second end. The first end includes first and second side faces that are configured to converge inwardly toward each other as they extend away from the center portion to a first tip portion that interconnects the first and second side faces. The first and second side faces and the first tip portion intersect with the forward face so as to define a first cutting edge. The second end includes third and fourth side faces that are configured to converge inwardly toward each other as they extend away from the center portion to a second tip portion. The third and fourth side faces and second tip portion intersecting with the forward face so as to define a second cutting edge. Each of the first cutting edge and the second cutting edge has a full involute configuration that matches a desired configuration of the gap between adjacent teeth.

In another aspect, the disclosure describes a cutting insert for a gear cutter for cutting a gap between adjacent teeth of a gear. The cutting insert includes a body having a forward face, a rear face and a center portion. The cutting insert has a first end and a second end each of which is configured to cut a full involute gear form geometry. The first end includes first and second side faces that are configured to converge inwardly toward each other as they extend away from the center portion to a first tip portion that interconnects the first and second side faces. The first and second side faces and the first tip portion intersect with the forward face so as to define a first cutting edge. The second end includes third and fourth side faces that are configured to converge inwardly toward each other as they extend away from the center portion to a second tip portion. The third and fourth side faces and second tip portion intersect with the forward face so as to define a second cutting edge. Each of the first cutting edge and the second cutting edge has a full involute configuration that matches a desired configuration of the gap between adjacent teeth.

In yet another aspect, the disclosure describes a gear cutter for cutting a gap between adjacent teeth of a gear. The gear cutter includes a body member that is configured to be rotatable about a rotational axis, the body member having a perimeter. At least one cutting insert is mounted to the perimeter of the body member and includes a forward face, a rear face and a center portion. The cutting insert has a first end and a second end each of which is configured to cut a full involute gear form geometry. The first end includes first and second side faces that are configured to converge inwardly toward each other as they extend away from the center portion to a first tip portion that interconnects the first and second side faces. The first and second side faces and the first tip portion intersect with the forward face so as to define a first cutting edge. The second end includes third and fourth side faces that are configured to converge inwardly toward each other as they extend away from the center portion to a second tip portion. The third and fourth side faces and second tip portion intersect with the forward face so as to define a cutting edge. Each of the first cutting edge and the second cutting edge has a full involute configuration that matches a desired configuration of the gap between adjacent teeth. The cutting insert is mounted on the body member such that the first and second cutting edges of the cutting insert extend at a negative rake angle relative to a radial line of the body member.

### BRIEF DESCRIPTION OF THE DRAWINGS

FIG. 1 is a side view of an exemplary gear cutter according to the present disclosure.

FIG. 2 is an end view of the gear cutter of FIG. 1.

FIG. 3 is an enlarged, partial perspective view of the gear cutter of FIG. 1 showing several cutting inserts according to the present disclosure.

FIG. 4 is an enlarged, partial perspective view of the gear cutter of FIG. 1 showing a cutting insert removed to reveal the mounting pocket for the insert.

FIG. 5 is a front perspective view of a cutting insert according to present disclosure.

FIG. 6 is a front perspective view of another embodiment of a cutting insert according to the present disclosure.

FIG. 7 is a enlarged, partial side view showing the cutting insert of FIG. 6 mounted to a gear cutter according to the present disclosure.

### DETAILED DESCRIPTION

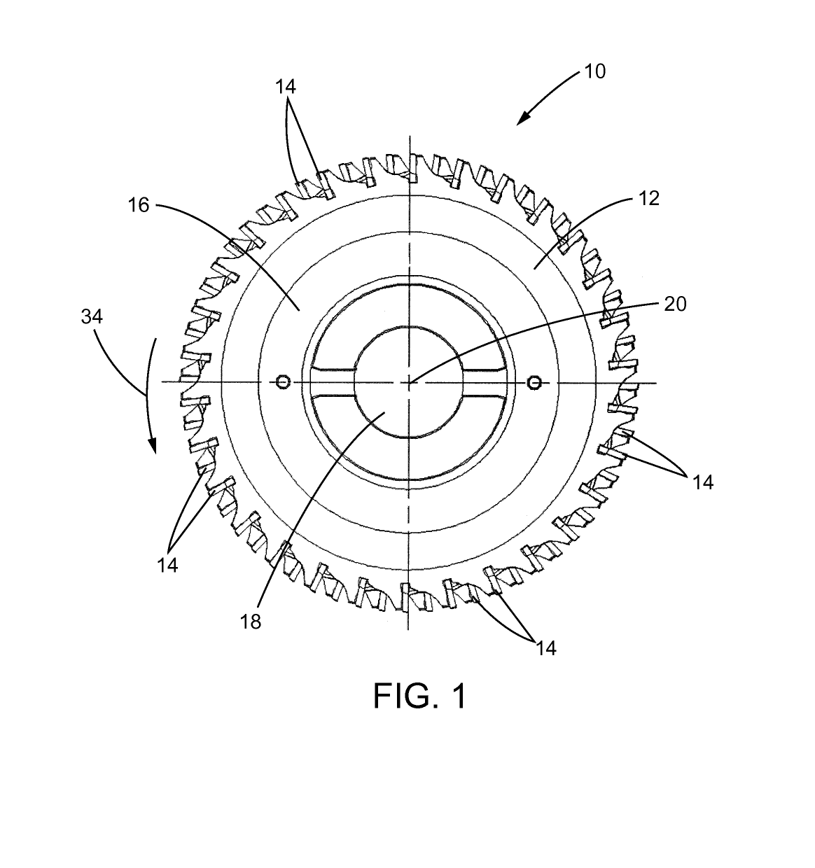

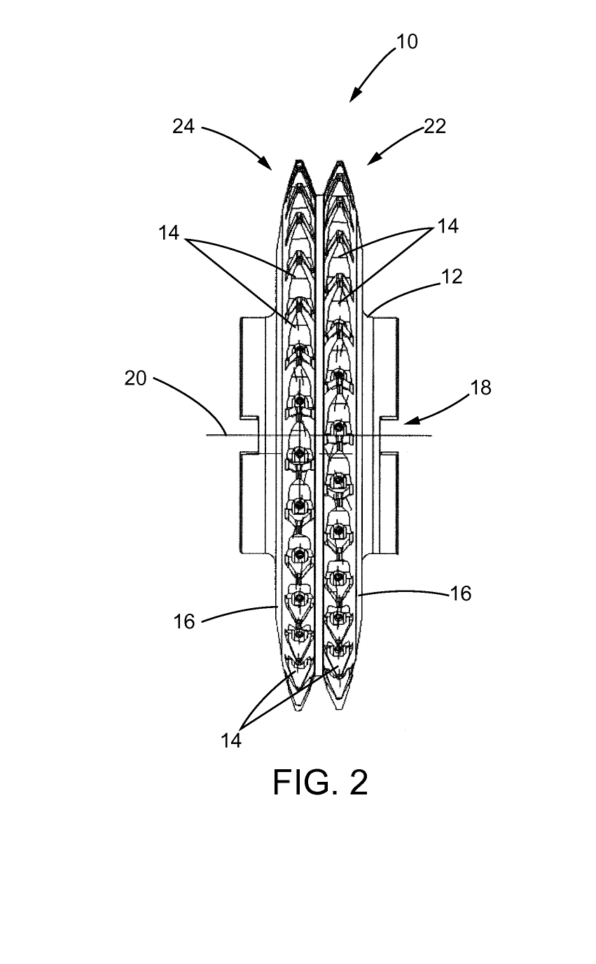

This disclosure generally relates to a gear cutter and an associated cutting insert for generating a tooth of a gear. With particular reference to FIGS. 1 and 2, an exemplary embodiment of a gear cutter 10 according to the present disclosure is shown. The illustrated gear cutter 10 is particularly suited for producing a tooth of a ring gear. For example, the illustrated gear cutter 10 may be, used to generate a tooth on the inner diameter of a ring gear. However, it will be understood by those skilled in the art that the gear cutter 10 of the present disclosure is not limited to use in the formation of any particular gear type including, for example, ring gears. Rather, the gear cutter 10 may be used in the formation of any suitable gear type.

The gear cutter 10 may include a body member 12 on which a plurality of cutting inserts 14 are supported. As shown in FIGS. 1 and 2, the body member 12 may have a generally disc-like shape with opposing lateral sides 16 of substantially identical construction. The body member 12 may have a central mounting opening 18 that extends between the lateral sides 16 of the body member 12 and defines a rotational axis 20 of the gear cutter. For example, the central mounting opening 18 of the body member 12 may receive a rotatable spindle of a machine tool that may drive rotational movement of the gear cutter 10 about the rotational axis 20. The body member 12 of the gear cutter 10 may be configured so as to be rotationally symmetric with respect to the rotational axis 20. As used herein, references to the axial direction are with reference to the rotational axis 20 of the gear cutter 10 and references to the radial direction are with respect to the body member 12 of the gear cutter 10.

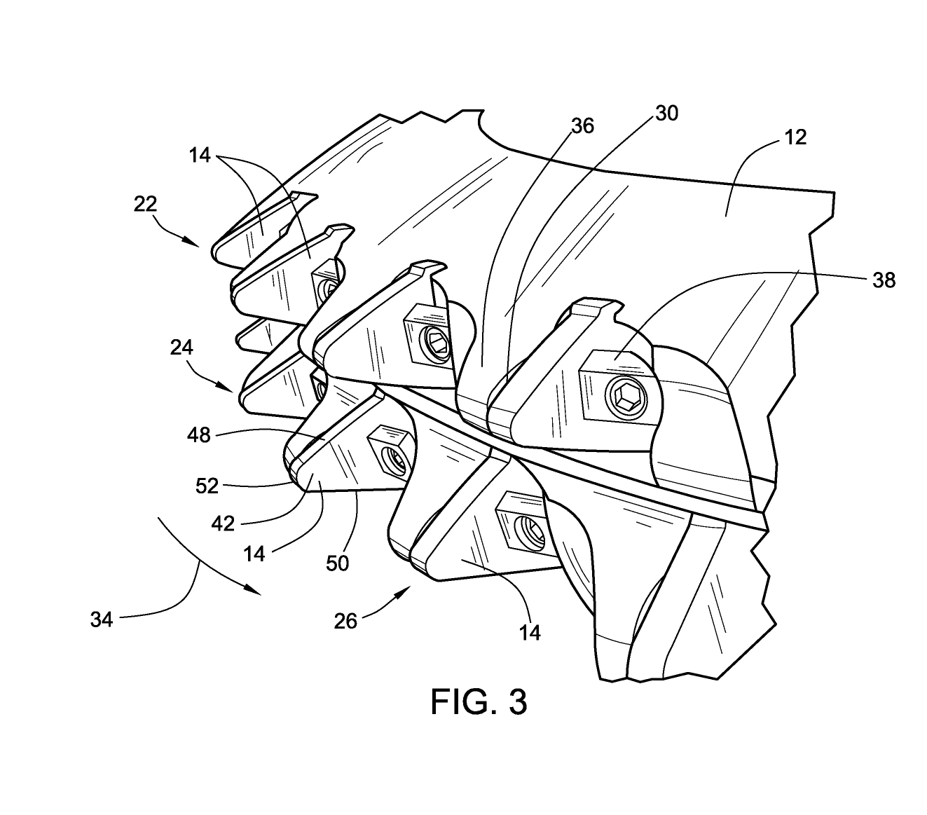

The plurality of cutting inserts 14 may be arranged about the perimeter of the body member 12 of the gear cutter 10. In the illustrated embodiment, the cutting inserts 14 are arranged in axially spaced first and second rows 22, 24 each of which includes a plurality of cutting inserts 14 and extends around the entire perimeter of the body member 12. In each of the first and second rows 22, 24, the plurality of cutting inserts 14 are spaced apart from each other in the circumferential direction of the body member 12 and are evenly distributed about the perimeter of the body member 12. As described in further detail below, each of the cutting inserts 14 may be supported on the body member 12 of the gear cutter 10 so as to protrude in a radial direction outward from the body member 12 (see, e.g., FIG. 3). In the illustrated embodiment, each of the first and second rows 22, 24 includes thirty cutting inserts 14. However, it will be appreciated by those skilled in the art, that the number of cutting inserts 14 included in each of the rows may vary depending upon the particular gear cutting application.

In the illustrated embodiment, the cutting inserts 14 in the first row 22 are arranged in staggered relationship with respect to the cutting inserts 14 in the second row 24 and vice versa as shown, for example, in FIGS. 2 and 3. In other words, the cutting inserts 14 of the first and second rows 22, 24 are not arranged directly across from each other in the axial direction. According to another embodiment, the cutting inserts 14 of the first and second rows 22, 24 may be arranged directly across from one another in the axial direction. In particular, with such a configuration, each cutting insert 14 in the first row 22 may extend in a coplanar relationship with the opposing cutting insert 14 in the second row 24. Whether the cutting inserts 14 of the first and second rows 22, 24 are arranged in a staggered or a coplanar relationship with the cutting inserts 14 of the other row may depend upon the dynamic response of the machine tool in which the gear cutter 10 is mounted.

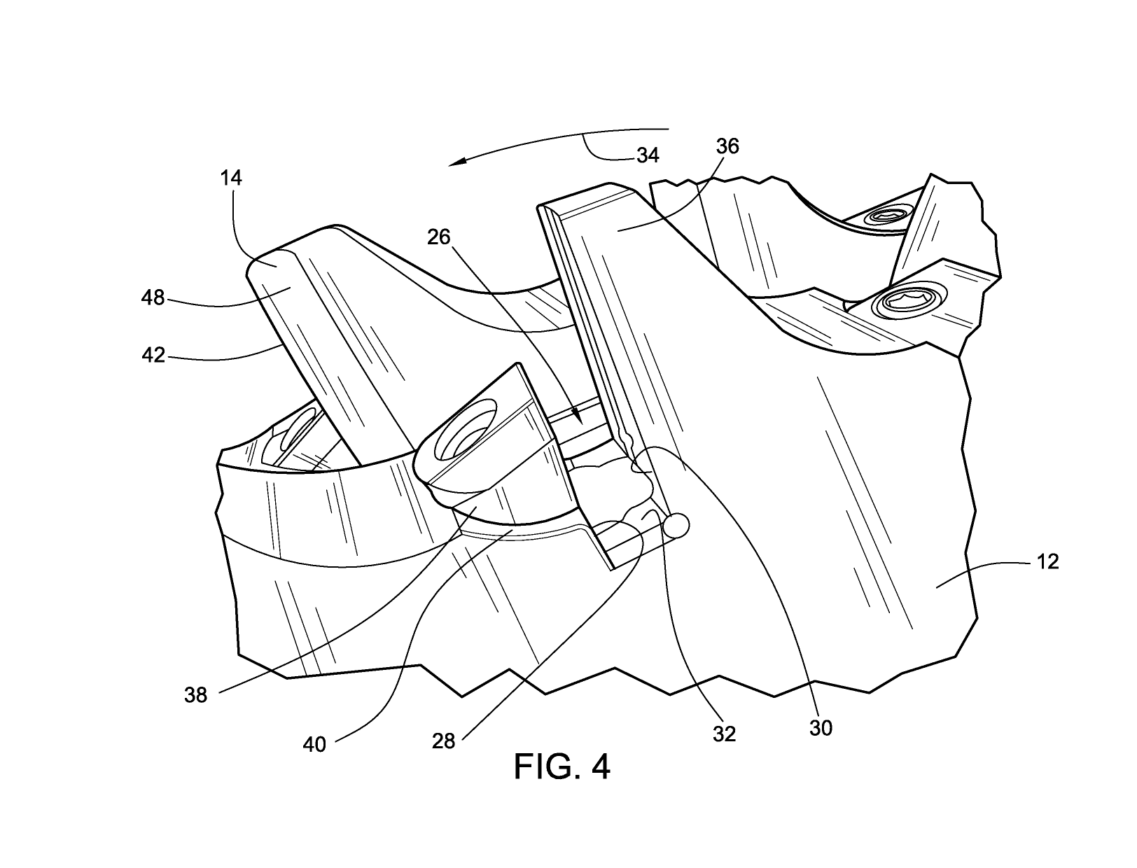

For receiving the cutting inserts 14, the body member 12 may be configured with a plurality of mounts 26 arranged around the periphery of the body member 12 of the gear cutter 10 to which the cutting inserts 14 may be connected. Moreover, each mount 26 may be configured such that the cutting inserts 14 may be easily removed and replaced, such as when the cutting insert becomes worn after use or when configuring the gear cutter 10 to cut a different type of gear. One way in which the mounts 26 may be configured are as mounting pockets such as shown in FIGS. 3 and 4, with each pocket being configured to receive a respective cutting insert 14. Another mounting arrangement that may be used for the cutting inserts 14 is a stick-type arrangement in which the mounts 26 on the body member 12 of the gear cutter 10 are configured such that the cutting inserts 14 may be attached to, for example, the outer circumference of the body member 12 via, for example, mounting openings, with the cutting inserts 14 extending outward in the radial direction, like sticks, from the body member 12. With such an arrangement, the cutting inserts 14 may be removed from the mounts 26 on the body member 12 and re-sharpened as they become dull from use. Such an arrangement is known in bevel gear cutting applications.

Referring to FIG. 4 of the drawings, one mount 26 is shown configured as a pocket with the cutting insert 14 removed. In the illustrated embodiment, the mounts 26 are arranged in two axially spaced rows around the perimeter of the body member 12 so as to produce the first and second rows 22, 24 of cutting inserts when the cutting inserts 14 are mounted to the mounts 26. Further, in the illustrated embodiment, the mounts 26 are configured such that cutting inserts 14 when connected to the mounts 26 extend in the radial direction relative to the body member 12. In other embodiments, the cutting inserts may be oriented differently relative to radii of the body member 12. When configured as a pocket, each mount 26 may be open at the radially outward end and include a forward wall 28, a rear wall 30 and a bottom wall 32. The rear wall 30 of the mount 26 may provide a support surface for the cutting insert 14 that can absorb forces exerted on the cutting insert 14 as the gear cutter 10 rotates in a cutting direction 34 (shown in FIGS. 1, 3 and 4) and the cutting insert 14 engages with a gear blank in order to cut a tooth of a gear. Moreover, the rear wall 30 of each mount 26 may be defined by a thickened flange 36 that extends rearward from the mount 26 and serves to support the respective cutting insert 14 and to separate the cutting insert 14 in the mount 26 from the succeeding cutting insert 14 and mount 26 in the circumferential direction.

When configured as pocket, each mount 26 may have an associated clamping member 38 which may be operable to help secure the cutting insert 14 in the mount 26. For example, as shown in FIG. 4, a clamping member 38 may be arranged on an inclined surface 40 at the upper edge of the forward wall 28 of the mount 26 and be configured to move in a rearward direction (i.e., towards the rear wall 30 of the mounting pocket 26) when an associated set screw is tightened relative to the clamping member 38. As the clamping member 38 moves rearward, it engages with the cutting insert 14 and helps capture the cutting insert 14 between the rear wall 30 of the mount 26 and the clamping member 38. While a specific mounting pocket configuration and clamping system is shown in the drawings, it will be appreciated by those skilled in the art that the present disclosure is not limited to a particular insert mounting system or configuration and, in particular is not limited to the use of a pocket-type arrangement. In this respect, the use of the term “insert” herein is not intended to imply the cutting insert must be mounted on the gear cutter via a mounting pocket.

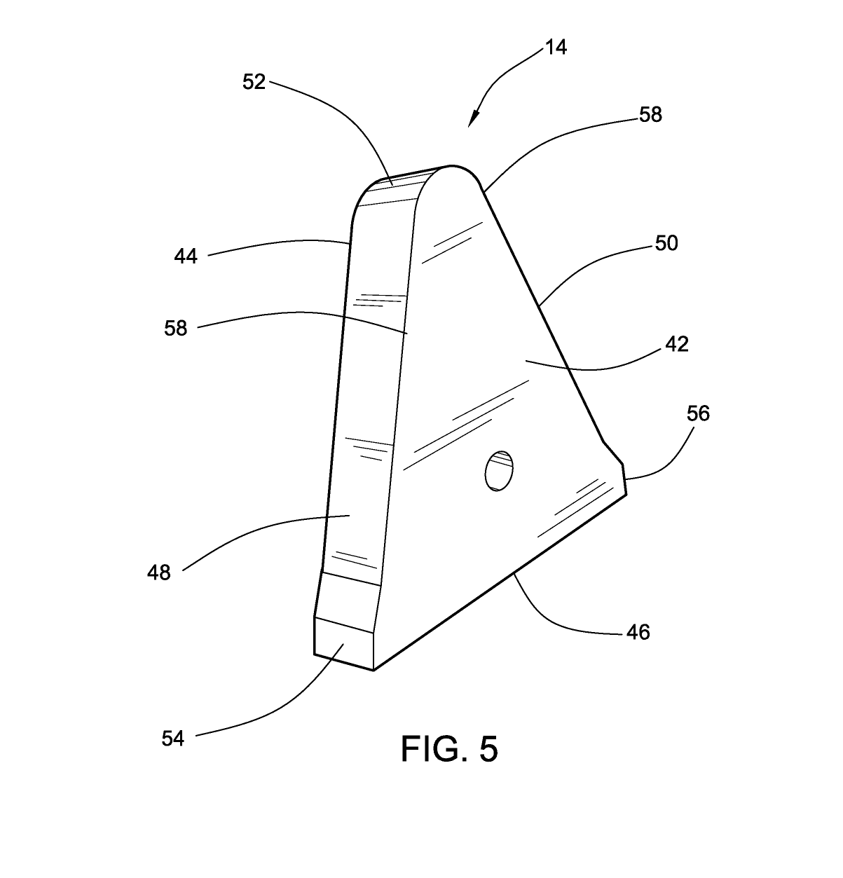

As best shown in FIG. 5, each of the cutting inserts 14 may be configured so as to be able to form the full gap between two adjacent teeth of a gear. In this respect, each of the cutting inserts 14 may have a full involute configuration that mirrors or matches in a one-to-one relationship the desired configuration of the tooth flanks defining the gap. To this end, each cutting insert 14 may have a generally triangular prism shape including a generally triangular forward face 42, a generally triangular rear face 44, a base 46 and first and second side faces 48, 50. The first and second side faces 48, 50 may be configured to converge inward towards each other as they extend upward from the base 46 to a distal tip portion 52. The distal tip portion 52 may interconnect the first and second side faces 48, 50 of the cutting insert 14 and may have any configuration required by the design of the gear to be manufactured. Often, the distal tip portion 52 may be rounded. In the illustrated embodiment, a lower portion 54, 56 of each of the first and second side faces 48, 50 of the cutting insert 14 extends in perpendicular relation upward from the base 46 of the cutting insert 14. Above these lower portions 54, 56, the first and second side faces 48, 50 converge continuously inward towards each other until reaching the tip portion 52. The illustrated cutting insert 14 has an initial section just above the lower portions 54, 56 of the first and second side faces 48, 50 in which the side faces angle toward at each other at a greater angle relative to the longitudinal axis of the cutting insert 14 than the remaining portion of the first and second side faces 48, 50.

A cutting edge 58 of the cutting insert 14 may be defined by where the first and second side faces 48, 50 and tip portion 52 intersect with the forward face 42 of the cutting insert 14. With such an arrangement, the portion of the cutting edge 58 defined by the first side face 48 may cut one flank of a gear tooth while the portion of the cutting edge 58 defined by the second side face 50 may cut one flank of the next gear tooth. The flanks of the two adjacent gear teeth may form the sides that converge to a bottom of a single gap between adjacent teeth of the gear. As will be appreciated by those skilled in the art, the precise configuration of the forward face 42, rear face 44 and first and second side faces 48, 50 of the cutting insert 14 and the resultant cutting edge 58 may be modified depending upon the particular gear configuration desired to be produced.

When received in the respective pocket-type mounts 26 shown, for example, in FIGS. 3 and 4, the cutting insert 14 may be oriented with the base 46 of the cutting insert 14 engaged with the bottom wall 32 of the mount 26 and the rear face 44 of the cutting insert 14 engaging the rear wall of the mount 26 as shown in FIG. 3. Additionally, a lower portion of the forward face 42 of the cutting insert 14 may engage with the forward wall 28 of the mount 26 with the clamping member 38 also engaging the forward face 42 of the cutting insert 14. If a stick-type mounting arrangement is to be used, the cutting insert 14 may be configured with an extended base or stem portion that is received in a corresponding mounting opening in the body member 12 of the gear cutter 10. In the illustrated embodiment, the cutting insert 14 has an opening that extends through the insert between the forward face 42 and the rear face 44. This opening may facilitate manufacture of the cutting insert 14. However, the cutting insert 14 may also be configured without any opening.

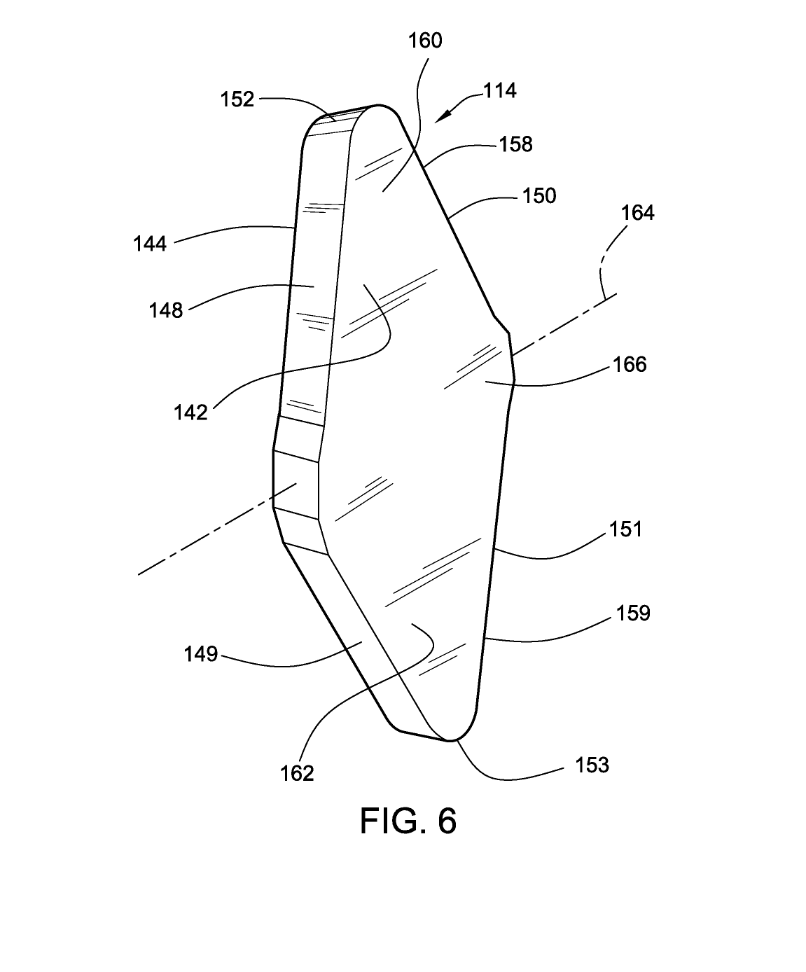

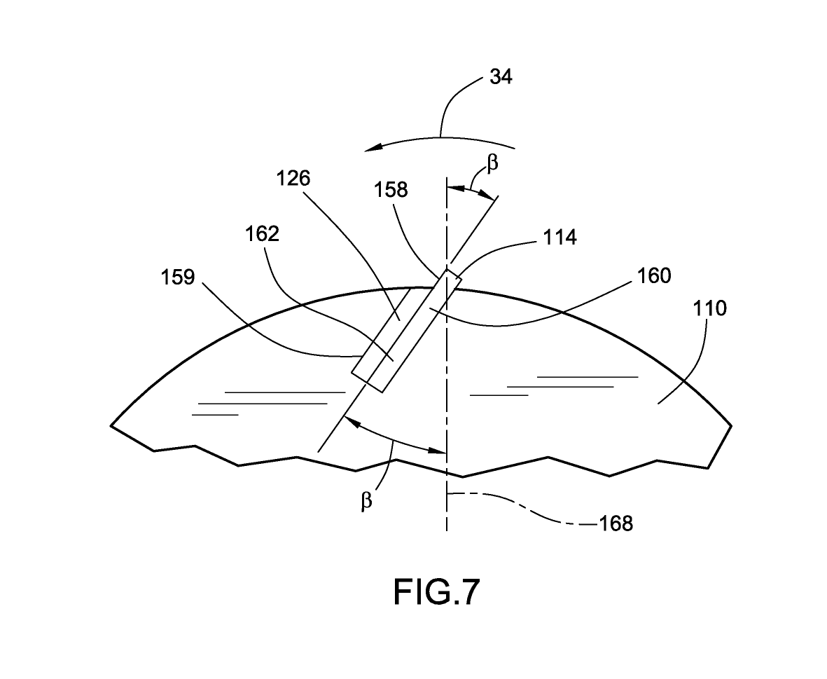

A further embodiment of a cutting insert 114 and gear cutter 110 according to the present disclosure are shown in FIGS. 6 and 7. The cutting insert 114 shown in FIG. 6 is configured with two alternately usable ends each of which is configured substantially the same as the cutting insert 14 of FIG. 5. In particular, the cutting insert 114 of FIG. 6 has a first end 160 and a second end 162 each of which is configured with the full involute gear form geometry. In other words, each end 160, 162 of the cutting insert 114 has a full involute configuration that mirrors or matches in a one-to-one relationship the desired configuration of the tooth flanks defining the gap between two adjacent teeth of a gear. Thus, both ends 160, 162 of the cutting insert 114 may be used in non-generative or profile milling applications. In the illustrated embodiment, the first and second ends 160, 162 of the cutting insert 114 are substantially identical such that the cutting insert is symmetrical about the transverse axis 164 of the cutting insert 114.

As shown in FIG. 6, the cutting insert 114 may have a body with a forward face 142, a rear face 144, first and second side faces 148, 150 on the first end 160 and third and fourth side faces 149, 151 on the second end 162. The first and second side faces 148, 150 of each of the first end 160 may be configured to converge inward towards each other and the third and fourth side faces 149, 151 of the second end 162 may be configured to converge inward towards each other as each side face extends away from a center portion 166 of the cutting insert 114 to a respective distal tip portion. A first distal tip portion 152 may interconnect the first and second side faces 148, 150 of the first end 160 of the cutting insert 114 and a second distal tip portion 153 may interconnect the third and fourth side faces 149, 151 of the second end 162. Each of the first and second distal end portions 152, 153 and may have a generally rounded configuration. The first end 160 of the cutting insert 114 may have a first cutting edge 158 defined by where the first and second side faces 148, 150 and the first tip portion 152 intersect with the forward face 142 of the cutting insert 114. Similarly, the second end 162 of the cutting insert 114 may have a second cutting edge 159 defined by where the third and fourth side faces 149, 151 and the second tip portion 152 intersect with the forward face 142 of the cutting insert 114. The first and second cutting edges 158, 159 may have substantially the same configuration. With this configuration, the cutting insert 114 can be removed from a gear cutter when, for example, the first end 160 becomes dull from use, inverted to expose the second end 162 and remounted to the gear cutter with the cutting edge of the second end 162 of the cutting insert 114 positioned to perform cutting operations.

As shown in FIG. 7, the dual ended cutting insert 114 of FIG. 6 may be mounted to a gear cutter 110 having a substantially similar configuration to the gear cutter shown in FIGS. 1 and 2. The cutting direction 34 of the gear cutter 110 is referenced as 34 in FIG. 7. As further shown in FIG. 7, the cutting insert 114 may be mounted on the gear cutter with a negative radial rake angle B. The rake angle B may be considered as the angle formed between the cutting edges 148, 149 of each end 160, 162 of the cutting insert 114 and a radial line 168 defined by the gear cutter 110 when the gear cutter is viewed from the side such as in FIG. 7. The rake angle B thus defines the angle of the cutting insert 114 relative to the work piece when the gear cutter 110 is brought into engagement therewith. In this case, the negative radial rake angle B of the cutting insert 114 is provided by mounting the cutting insert 114 in a mount 126, such as a pocket, that extends at the negative radial rake angle. While a single cutting insert 114 is shown received in a complementary mount 126 configured as a pocket on the gear cutter in FIG. 7, a plurality of the dual ended cutting inserts 114 may be mounted on the gear cutter 110 in circumferentially spaced relation and may be mounted in multiple rows substantially similarly to the gear cutter 10 of FIGS. 1 and 2. Moreover, any suitable mounting arrangement may be used to secure the cutting inserts 114 to the gear cutter 110 including, for example, a stick-type arrangement.

### INDUSTRIAL APPLICABILITY

The gear cutter 10 and associated cutting insert 14 of the present disclosure can be used in the generation of any type of compatible gear. During a gearing cutting operation, the gear cutter 10 may be supported so as to rotate and also move axially relative to the rotary axis of a gear blank. As the gear cutter 10 makes a single axial pass relative to the gear blank, the two rows of cutting inserts 14 on the gear cutter 10 may cut two gaps between adjacent teeth into the gear blank. Thus, the gear cutter 10 can effectively cut two gear teeth into the blank at once in a single pass of the gear cutter 10. Moreover, the use of two axially spaced rows 22, 24 of cutting inserts 14 each configured to cut the full form of a tooth gap allows the gear cutter 10 to be capable of both roughing and finishing of a gear without any change in tooling. This can be a substantial time savings as compared to tooling that can only perform the roughing or finishing step. The resultant gears produced by the gear cutter 10 also can have a higher quality because there is no need to hold tolerances and maintain consistency between separate cutting operations.

The use of cutting inserts 14 that are configured to cut the full form of a tooth gap allows spacing between same gap inserts on the gear cutter 10 to be minimized which effectively maximizes the total number of cutting inserts 14 operating on each gap. In particular, as opposed to having separate left flank and right flank cutting inserts, a single cutting insert 14 that cuts the full form of the tooth gap (i.e., simultaneously cuts both flanks) effectively allows more inserts to be arranged around the perimeter of the gear cutter 10 in that each cutting insert cuts both flanks as opposed to every other insert cutting one flank. Maximizing the number of cutting inserts operating on each gap can substantially reduce cycle times of the gear cutter.

Configuring the cutting insert 114 such that it is dual ended effectively doubles the utilization of a piece of material, such as carbide, used to create the insert. Once the cutting edge on one end of the insert becomes worn, the cutting insert can be inverted so that the cutting edge on second end of the insert can be used. This provides the cutting insert with a significantly longer life as compared to cutting inserts having a single end that must be removed and recycled when the cutting edge on the single end becomes worn. Arranging the dual ended cutting insert at a negative rake angle may allow for improved chip management as compared to neutrally raked inserts and may eliminate the need to grind clearance into the insert.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

I claim:

1. A gear cutter for cutting a gap between adjacent teeth of a gear comprising:
a body member that is configured to be rotatable about a rotational axis, the body member having a perimeter; and
at least one cutting insert mounted on the perimeter of the body member and including a forward face, a rear face and a center portion, the cutting insert having a first end and a second end, the first end including first and second side faces that are configured to converge inwardly toward each other as they extend away from the center portion to a first tip portion that interconnects the first and second side faces, the first and second side faces and the first tip portion intersecting with the forward face so as to define a first cutting edge, the second end including third and fourth side faces that are configured to converge inwardly toward each other as they extend away from the center portion to a second tip portion, the third and fourth side faces and second tip portion intersecting with the forward face so as to define a second cutting edge, each of the first cutting edge and the second cutting edge having a full involute configuration that matches a desired configuration of the gap between adjacent teeth.

2. The gear cutter of claim 1 wherein the at least one cutting insert is one of a plurality of substantially identical cutting inserts, each of the cutting inserts being received in a respective mount on the body member with the cutting inserts being arranged around the perimeter of the body member.

3. The gear cutter of claim 2 wherein each mount is configured as a pocket.

4. The gear cutter of claim 2 wherein each of the plurality of cutting inserts is mounted on the body member such that the first and second cutting edges of the each cutting insert extend at a negative rake angle relative to a respective radial line of the body member.

5. The gear cutter of claim 2 wherein the plurality of cutting inserts are arranged in a first row and a second row which are spaced apart from each other in the direction of the rotational axis of the body member.

6. The gear cutter of claim 1 wherein the body member has a disc-like shape.

7. The gear cutter of claim 1 wherein the first cutting edge and the second cutting edge have substantially the same configuration.

8. The gear cutter of claim 1 wherein the cutting insert is substantially symmetrical about a transverse axis.

9. The gear cutter of claim 1 wherein the first and second tip portions are rounded.

10. A cutting insert for a gear cutter for cutting a gap between adjacent teeth of a gear comprising:
a body having a forward face, a rear face and a center portion, the cutting insert having a first end and a second end each of which is configured to cut a full involute gear form geometry, the first end including first and second side faces that are configured to converge inwardly toward each other as they extend away from the center portion to a first tip portion that interconnects the first and second side faces, the first and second side faces and the first tip portion intersecting with the forward face so as to define a first cutting edge, the second end including third and fourth side faces that are configured to converge inwardly toward each other as they extend away from the center portion to a second tip portion, the third and fourth side faces and second tip portion intersecting with the forward face so as to define a second cutting edge, each of the first cutting edge and the second cutting edge having a full involute configuration that matches a desired configuration of the gap between adjacent teeth.

11. The cutting insert of claim 10 wherein the first cutting edge and the second cutting edge have substantially the same configuration.

12. The cutting insert of claim 10 wherein the cutting insert is substantially symmetrical about a transverse axis.

13. The cutting insert of claim 10 wherein the first and second tip portions are rounded.

14. A gear cutter for cutting a gap between adjacent teeth of a gear, the gear cutter comprising:
a body member that is configured to be rotatable about a rotational axis, the body member having a perimeter; and
at least one cutting insert mounted to the perimeter of the body member and including a forward face, a rear face and a center portion, the cutting insert having a first end and a second end each of which is configured to cut a full involute gear form geometry, the first end including first and second side faces that are configured to converge inwardly toward each other as they extend away from the center portion to a first tip portion that interconnects the first and second side faces, the first and second side faces and the first tip portion intersecting with the forward face so as to define a first cutting edge, the second end including third and fourth side faces that are configured to converge inwardly toward each other as they extend away from the center portion to a second tip portion, the third and fourth side faces and second tip portion intersecting with the forward face so as to define a cutting edge, each of the first cutting edge and the second cutting edge having a full involute configuration that matches a desired configuration of the gap between adjacent teeth;
wherein the cutting insert is mounted on the body member such that the first and second cutting edges of the cutting insert extend at a negative rake angle relative to a radial line of the body member.

15. The gear cutter of claim 14 wherein the at least one cutting insert is one of a plurality of substantially identical cutting inserts, each of the cutting inserts being received in a respective mount on the body member with the cutting inserts being arranged around the perimeter of the body member.

16. The gear cutter of claim 15 wherein the plurality of cutting inserts are arranged in a first row and a second row which are spaced apart from each other in the direction of the rotational axis of the body member.

17. The gear cutter of claim 14 wherein the body member has a disc-like shape.

18. The gear cutter of claim 14 wherein the first cutting edge and the second cutting edge have substantially the same configuration.

19. The gear cutter of claim 14 wherein the cutting insert is substantially symmetrical about a transverse axis.

20. The gear cutter of claim 14 wherein the first and second tip portions are rounded.
